(19) United States
(12) Patent Application Publication
(10) Pub. No.: US 2024/0411562 A1
(43) Pub. Date: Dec. 12, 2024

(54) METHOD AND ELECTRONIC DEVICE WITH PROCESS COUNT DETERMINATION FOR EXECUTING APPLICATION

(71) Applicant: SAMSUNG ELECTRONICS CO., LTD., Suwon-si (KR)

(72) Inventors: Jae-Eon JO, Suwon-si (KR); Rohyoung MYUNG, Suwon-si (KR)

(73) Assignee: SAMSUNG ELECTRONICS CO., LTD., Suwon-si (KR)

(21) Appl. No.: 18/461,766

(22) Filed: Sep. 6, 2023

(30) Foreign Application Priority Data
Jun. 8, 2023 (KR) 10-2023-0073552

(51) Int. Cl. G06F 9/38; G06F 9/50

(52) U.S. Cl. CPC G06F 9/3885; G06F 9/5038

(57) ABSTRACT

A process-implemented method includes: based on obtaining a job description on an application, determining a wall clock time of the application according to processes of a corresponding candidate count for each of a plurality of candidate counts; determining parallelization efficiency for each of the candidate counts based on the determined wall clock time and a wall clock time of the application according to a single process; and executing the application with processes of a target count selected based on the determined parallelization efficiency among the plurality of candidate counts.

### CROSS-REFERENCE TO RELATED APPLICATIONS

This application claims the benefit under 35 USC § 119 (a) of Korean Patent Application No. 10-2023-0073552, filed on Jun. 8, 2023 in the Korean Intellectual Property Office, the entire disclosure of which is incorporated herein by reference for all purposes.

### BACKGROUND

### 1. Field

The following description relates to a method and electronic device with a process count determination for executing an application.

### 2. Description of Related Art

Message passing interface (MPI) is a standard interface for applied scientists to execute a parallel program on a high-performance computer and is a parallel processing library based on a message passing technique. The MPI may describe a basic function, syntax, and programming application programming interface (API) used when exchanging information in parallel processing.

The MPI may perform the entire parallel processing task by transmitting and receiving messages between each parallel processing process participating in an application with its own identifier (ID) (hereinafter also referred to as a “rank”). Accordingly, the MPI parallel process may be configured to be executed by explicitly inputting a process count and a hostname of a computer participating in a task by the request of a user.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a process-implemented method includes: based on obtaining a job description on an application, determining a wall clock time of the application according to processes of a corresponding candidate count for each of a plurality of candidate counts; determining parallelization efficiency for each of the candidate counts based on the determined wall clock time and a wall clock time of the application according to a single process; and executing the application with processes of a target count selected based on the determined parallelization efficiency among the plurality of candidate counts.

The determining of the wall clock time may include, for a call of a function in the application, determining latency of a function call context, and the function call context may include any one or any combination of any two or more of the application, a parameter of the application, the function, an argument of the function, a call stack of the function, hardware allocated to the function, a mapping relationship between a process and hardware, and a global variable.

The determining of the latency of the function call context may include a cumulative latency of the function call context using a unit latency of the function call context and a number of repetitions of the function call context, based on repetition of the function call context.

The determining of the latency of the function call context may include determining a number of repetitions of the function call context based on the function call context.

The determining of the latency of the function call context may include, in response to a difference between a first function call context and a second function call context being less than or equal to a threshold, determining that one of the first function call context and the second function call context is repeatedly performed.

The determining of the latency of the function call context may include, based on the function comprising a plurality of types of operations, determining the latency of the function call context using a coefficient of variation (CV) of a ratio of an operation execution time for each operation type for an operation execution time of the operations.

The method may include: obtaining a job description on other applications; and determining latency of a function context called by the other applications using a latency model corresponding to a function in the application, based on the application and the other applications comprising the same function.

The method may include training a wall clock time model corresponding to the application based on the target count and a wall clock time of the application obtained as a result of executing the application with processes of the target count.

The training of the wall clock time model may include, based on other applications comprising a function in the application, training a latency model corresponding to the function using the target count and latency of a function call context obtained as a result of executing a call of the function in the application with processes of the target count.

The executing of the application may include selecting a candidate count having a minimum wall clock time as the target count among candidate counts having parallelization efficiency greater than or equal to threshold parallelization efficiency.

In one or more general aspects, an electronic device includes: one or more processors configured to: based on obtaining a job description on an application, determine a wall clock time of the application according to processes of a corresponding candidate count for each of a plurality of candidate counts; determine parallelization efficiency for each of the candidate counts based on the determined wall clock time and a wall clock time of the application according to a single process; and execute the application with processes of a target count selected based on the determined parallelization efficiency among the plurality of candidate counts.

For the determining of the wall clock time may include, the one or more processors may be configured to, for a call of a function in the application, determine latency of a function call context, and the function call context may include any one or any combination of any two or more of the application, a parameter of the application, the function, an argument of the function, a call stack of the function, hardware allocated to the function, a mapping relationship between a process and hardware, and a global variable.

For the determining of the latency of the function call context, the one or more processors may be configured to determine a cumulative latency of the function call context using a unit latency of the function call context and a number of repetitions of the function call context, based on repetition of the function call context.

For the determining of the latency of the function call context, the one or more processors may be configured to determine a number of repetitions of the function call context based on the function call context.

For the determining of the latency of the function call context, the one or more processors may be configured to, in response to a difference between a first function call context and a second function call context being less than or equal to a threshold, process that one of the first function call context and the second function call context is repeatedly performed.

For the determining of the latency of the function call context, the one or more processors may be configured to, based on the function comprising a plurality of types of operations, determine the latency of the function call context using a coefficient of variation (CV) of a ratio of an operation execution time for each operation type for an operation execution time of the operations.

The one or more processors may be configured to: obtain a job description on other applications; and determine latency of a function context called by the other applications using a latency model corresponding to a function in the application, based on that the application and the other applications comprising the same function.

The one or more processors may be configured to train a wall clock time model corresponding to the application based on the target count and a wall clock time of the application obtained as a result of executing the application with processes of the target count.

For the training of the wall clock time model, the one or more processors may be configured to, based on other applications comprising a function in the application, train a latency model corresponding to the function using the target count and latency of a function call context obtained as a result of executing a call of the function in the application with processes of the target count.

For the executing of the application, the one or more processors may be configured to select a candidate count having a minimum wall clock time as the target count among candidate counts having parallelization efficiency greater than or equal to threshold parallelization efficiency.

Other features and aspects will be apparent from the following detailed description, the drawings, and the claims.

### BRIEF DESCRIPTION OF THE DRAWINGS

FIG. 1 illustrates an example of an electronic device.

FIG. 2 illustrates an example of a method of executing an application performed by an electronic device.

FIG. 3 illustrates an example of an electronic device determining a wall clock time of an application based on latency of a function call context.

FIG. 4 illustrates an example of an OpenCL platform model.

FIG. 5 illustrates an example of parallelism inherent in a function.

FIG. 6 illustrates an example of training a wall clock time model of an electronic device.

FIG. 7 illustrates an example of a reinforcement learning model for determining threshold parallelization efficiency.

FIG. 8 illustrates an example of an electronic device.

FIG. 9 illustrates an example of a modeling framework.

FIG. 10 illustrates an example of a modeling framework.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms of “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “connected to,” “coupled to,” or “joined to” another component or element, it may be directly (e.g., in contact with the other component or element) “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning. The use of the term “may” herein with respect to an example or embodiment, e.g., as to what an example or embodiment may include or implement, means that at least one example or embodiment exists where such a feature is included or implemented, while all examples are not limited thereto.

Hereinafter, examples will be described in detail with reference to the accompanying drawings. In the descriptions of the examples referring to the accompanying drawings, like reference numerals refer to like elements and any repeated description related thereto will be omitted.

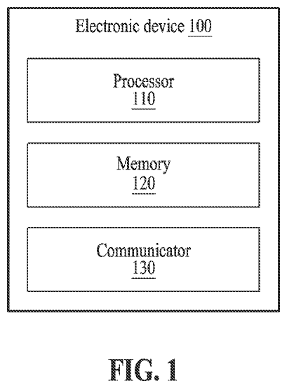

FIG. 1 illustrates an example of an electronic device.

An electronic device 100 may obtain a job description on an application. The job description may include information on an environment in which the application is executed. For example, the job description may include at least one of a command for executing the application, a parameter of the application, and/or a specification (e.g., a central processing unit (CPU) core count), a graphics processing unit (GPU) count, a memory size, and/or preference requirements for hardware) of a hardware resource used for executing the application according to the job description.

A job description on an application may include the process count. In a high-performance computing (HPC) application using a message passing interface (MPI), the parameter of the application may include the process count (e.g., N) and may use the CPU core count (e.g., N, 2N, and/or 3N) as an integer multiple of the process count to perform a plurality of processes (e.g., N processes) in parallel. For reference, when the CPU core count is an integer multiple (e.g., 2N or 3N) exceeding “1” of the process count, each process may be parallelized using a multi-core CPU through M OpenMP threads. In this case, the job description may request the CPU core count (e.g., N×M) equal to the product of the process count (e.g., N) and the OpenMP thread count (e.g., M) of each process. That is, the CPU core count of the job description may be determined as the product of the software-defined process count and the OpenMP thread count.

The electronic device 100 may determine a wall clock time of an application according to the process count. The wall clock time may represent the time consumed for an electronic device (e.g., a computer) to execute the application in practice. The wall clock time may further include the time consumed by input and/or output accesses with the time consumed by the CPU to execute the application.

The HPC application may be implemented such that the wall clock time of the application decreases by increasing a hardware resource input to execute the same application when the process count (e.g., the MPI process count) increases. Thus, the HPC application may obtain almost the same calculation result even when the process count (e.g., the MPI process count) is changed. However, increasing of the process count may not be desirable. Each process may independently perform an operation on different data but data communication between the processes may occur. The occurrence of the communication (e.g., the synchronization overhead) may increase as the process count increases. The amount of operation time decrease according to the increase of the process count may be greater than the amount of communication time increase, and as a result, when the process count is greater than or equal to a threshold, there may be an inflection point at which the wall clock time increases according to the increase of the process count.

In addition, the parallelization efficiency may continuously decrease as the process count increases before reaching the inflection point. Theoretically, when an application is executed with a plurality of processes (e.g., N processes) rather than a single process (e.g., one process), the operation time of each process may decrease by up to 1/N times that of the single process, and when the communication time is added according to the communication occurrence between the processes, a wall clock time may be greater than 1/N times the operation time of the single process in practice. Thus, in terms of an entire HPC system, executing at least one application(s) at the same time with the resource allocation of each application limited to an appropriate level may be more efficient in terms of the entire HPC system rather than sequentially executing applications with all HPC system resources always allocated to each application.

However, when a typical electronic device does not determine a wall clock time according to the process count, the typical electronic device may have difficulty determining and/or changing the process count. Alternatively, the electronic device 100 of one or more embodiments may determine a wall clock time according to the process count and execute an application with processes of a target count determined based on the wall clock time.

The electronic device 100 of one or more embodiments may execute an application with processes of a target count determined based on a determined wall clock time and parallelization efficiency.

The electronic device 100 may include a processor 110 (e.g., one or more processors), a memory 120 (e.g., one or more memories), and a communicator 130.

The processor 110 may obtain a job description on an application. The processor 110 may determine a wall clock time of the application according to processes of a corresponding candidate count for each of a plurality of candidate counts. The processor 110 may calculate (e.g., determine) parallelization efficiency for each of the candidate counts. The processor 110 may select a target count among the plurality of candidate counts based on the calculated parallelization efficiency. The processor 110 may execute the application with processes of the selected target count. The processor 110 may temporarily or permanently store data used for obtaining a job description, determining a wall clock time, calculating parallelization efficiency, selecting a target count, and/or executing an application in the memory 120.

The memory 120 may store information on an application, a job description, a wall clock time, parallelization efficiency, a candidate count, and/or a target count. The memory 120 may store instructions for obtaining the job description, determining the wall clock time, calculating parallelization efficiency, selecting the target count, and/or executing the application. In an example, the memory 120 may be or include a non-transitory computer-readable storage medium storing instructions that, when executed by the processor 110, configure the processor 110 to perform any one, any combination, or all of operations and methods described herein with reference to FIGS. 1-10.

The communicator 130 may transmit at least one of a job description, a wall clock time, parallelization efficiency, a candidate count, and/or a target count. The communicator 130 may establish a wired communication channel and/or a wireless communication channel with an external device, for example, may establish cellular communication, near field communication (NFC), local area network (LAN) communication, Bluetooth™, wireless-fidelity (Wi-Fi) direct or infrared data association (IrDA), a legacy cellular network, a fourth generation (4G) and/or 5G network, next-generation communication, the Internet, and/or communication via a long-range communication network, such as a computer network (e.g., a LAN or a wide area network (WAN)).

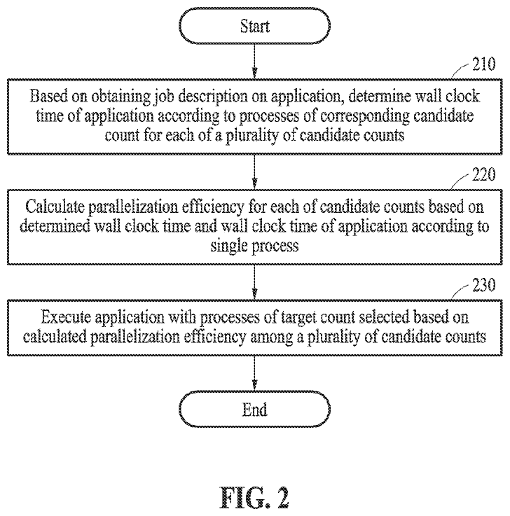

FIG. 2 illustrates an example of a method of executing an application performed by an electronic device.

When obtaining a job description on an application, an electronic device (e.g., the electronic device 100 of FIG. 1) may determine the count of processes (hereinafter also referred to as “a target count”) to be used for execution of the application based on a wall clock time according to the count of processes.

In operation 210, based on obtaining a job description on an application, the electronic device may determine a wall clock time of the application according to processes of a corresponding candidate count for each of a plurality of candidate counts.

The electronic device may determine the wall clock time of the application based on a wall clock time model corresponding to the application. The wall clock time model may output the wall clock time of the application by applying to at least one of the count of processes, the application (or an identifier (ID) of the application), and/or a parameter of the application.

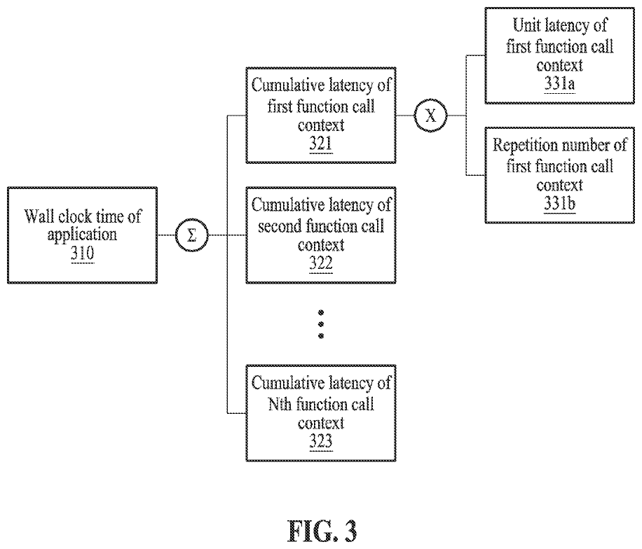

For example, the electronic device may determine the latency of a function call context for each of a plurality of functions in the application. The electronic device may determine the wall clock time of the application by cumulating latency determined for each of the plurality of functions. An example of determining the wall clock time of the application based on the latency of the function call context is described in detail below with reference to FIG. 3.

In operation 220, the electronic device may calculate parallelization efficiency for each of the candidate counts based on the determined wall clock time and the wall clock time of the application according to a single process.

The parallelization efficiency for the candidate count may be determined based on a ratio of the wall clock time and the candidate count of the application according to processes of the candidate count for the wall clock time of the application according to the single process. For example, the parallelization efficiency for the candidate count may be obtained by dividing the wall clock time of the application according to the single process by a value obtained by multiplying the wall clock time of the application according to the processes of the candidate count by a value of the candidate count. The parallelization efficiency for the candidate count may be calculated through Equation 1 below, for example.

$$P {E}_{N} = \frac{{wall}_{c l o c {k}_{t i m {e}_{1}}}}{N \times {wall}_{c l o c {k}_{t i m {e}_{N}}}} \qquad Equation 1$$

Here, N denotes a candidate count, PEN denotes parallelization efficiency when the candidate count is N, wall_{clocktimeN} denotes a wall clock time of an application according to N processes, and wall_{clocktime1} denotes a wall clock time of an application according to a single process.

For example, when the wall clock time of the application executed with N processes is executed by one process (e.g., a single process) and when the wall clock time of the application decreases to 1/N times, the parallelization efficiency for N may be determined as “1”. The parallelization efficiency may be a real number greater than or equal to “0” and less than or equal to “1”.

In operation 230, the electronic device may execute the application with processes of a target count selected based on the calculated parallelization efficiency among the plurality of candidate counts. The electronic device may select the target count among the plurality of candidate counts based on the calculated parallelization efficiency. The electronic device may execute the application with the processes of the target count.

The electronic device may select a candidate count having the minimum wall clock time as the target count among the candidate counts having parallelization efficiency greater than or equal to threshold parallelization efficiency. For example, when a first candidate count set among the candidate counts has parallelization efficiency less than the threshold parallelization efficiency and a second candidate count set among the candidate counts has parallelization efficiency greater than or equal to the threshold parallelization efficiency. the electronic device may determine the candidate count having the minimum wall clock time as the target count from the second candidate count set (that is, among the candidate counts having parallelization efficiency greater than or equal to the threshold parallelization efficiency among the candidate counts). The electronic device of one or more embodiments may determine both the parallelization efficiency and the decreased wall clock time due to the parallelization to an appropriate level by determining the candidate count having the minimum wall clock time among the candidate counts having the parallelization efficiency greater than or equal to the threshold parallelization efficiency as the target count.

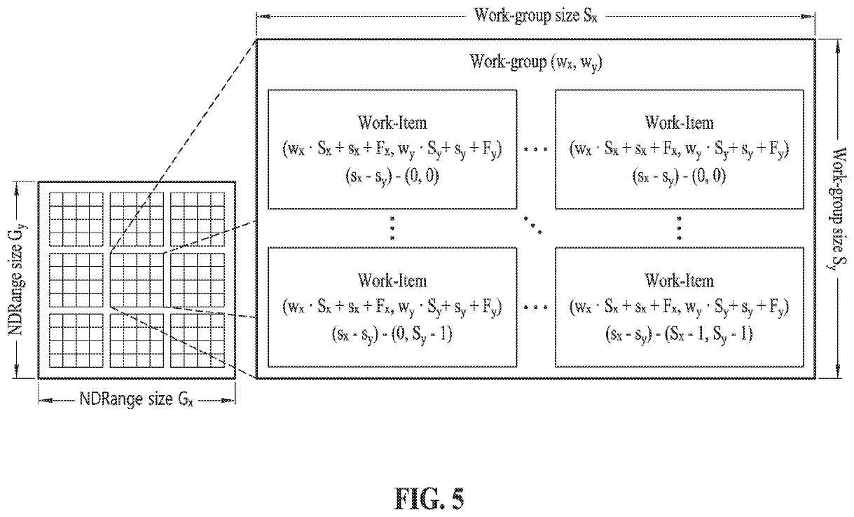

The electronic device may determine the threshold parallelization efficiency using reinforcement learning. The electronic device may select the candidate count having the minimum wall clock time as the target count among the candidate counts having the parallelization efficiency greater than or equal to the determined threshold parallelization efficiency. Based on the execution of the application, the electronic device may update the threshold parallelization efficiency using reinforcement learning. An example of the determination of the threshold parallelization efficiency using reinforcement learning is described in detail below with reference to FIG. 5.

Although not explicitly shown in FIG. 2, the electronic device may determine a default count as the target count when the wall clock time of the application is not determined according to the candidate counts. For example, the electronic device may use the wall clock time model corresponding to the application to determine the wall clock time of the application. The electronic device may determine the default count as the target count when the wall clock time model corresponding to the application is not stored (or registered) in a database. The default count may be a predetermined count.

FIG. 3 illustrates an example of an electronic device determining a wall clock time of an application based on latency of a function call context.

To determine a wall clock time of an application 310, an electronic device may determine the latency of function call contexts corresponding to a call of a function in the application and cumulate the determined latency of the function call contexts.

The electronic device, for the call of the function in the application, may determine the latency of a function call context, based on the function call context. The function call context may correspond to the call of the function. The function call context may include information on a time (e.g., the latency of the function call context) consumed to call a corresponding function. For example, the function call context may include at least one of an application, a parameter of the application, a function, an argument of the function, a call stack of the function, hardware allocated to the function, a mapping relationship between a process and hardware, and/or a global variable. The global variable may include a preset global variable to change a function execution pattern.

Table 1 below shows examples of the function call context.

TABLE 1
Function Call Context Components

| First Level | Second Level |
|---|---|
| Application | Name (or an ID) of Application |
| | Parameter of Application |
| Function (e.g., a callee) | Name (or an ID) of Function |
| | Argument of Function |
| | Call Stack of Function (e.g., a caller) |
| Hardware allocated | Hardware Type (e.g., NVIDIA A100 80G) |
| to Function | Setting Hardware (e.g., Divide GPU |
| | into 7 in an NVIDIA MIG mode |
| | and allocate one instance to a process) |

Here, the call stack of the function may store a name (or an ID) and/or a parameter of each function of the stack.

The electronic device may determine a cumulative latency of the function call context (e.g., a cumulative latency of a first function call context 321, a cumulative latency of a second function call context 322, and a cumulative latency of an Nth function call context 323) using a unit latency of the function call context and the number of repetitions of the function call context, based on repetition of the function call context. For example, when the first function call context 321 is repeated 10 times in an application, the cumulative latency of the first function call context 321 may be determined by multiplying a unit latency of a first function call context 331a corresponding to one time of the first function call context by “10”, which is a repetition number of a first function call context 331b.

When the difference between the first function call context and the second function call context is less than or equal to a threshold, the electronic device may process or determine that one of the first function call context and the second function call context is repeatedly performed.

The difference between the first function call context and the second function call context may include at least one of cosine similarity, a difference based on an embedding vector obtained by applying a machine learning model to the function call context, and/or similarity based on whether a predetermined element has the same value.

For a first call and a second call in an application, the difference between the first function call context and the second function call context corresponding to the first call may be less than or equal to a threshold. The electronic device, when the difference between the first function call context and the second function call context corresponding to the first call is less than or equal to the threshold, may process the first function call context and the second function call context as the same function call context. For example, the first function call context of a first repetition number and the second function call context of a second repetition number may be processed as a third function call context of a third repetition number obtained (e.g., determined) by summing the first repetition number and the second repetition number. The third function call context may be selected as either the first function call context or the second function call context but is not limited thereto, and may be a function call context that is different from the first function call context and the second function call context.

The electronic device may use a latency model corresponding to a function to calculate the latency of the function call context. A wall clock model corresponding to an application may include the latency model and/or a repetition number model corresponding to the function based on the application including the call of the function.

For example, the electronic device may determine the latency of the function call context by applying the latency model corresponding to the function to the function call context. The function call context may include information used as an input of the latency model corresponding to the function.

The electronic device may determine the number of repetitions of the function call context based on the function call context. The electronic device may determine the cumulative latency of the function call context based on the determined number of repetitions. For example, the electronic device may determine the number of repetitions of the function call context by applying the repetition number model corresponding to the function to the function call context. The electronic device may determine the unit latency of the function call context by applying the latency model corresponding to the function to the function call context. The electronic device may determine the cumulative latency of the function call context based on the determined number of repetitions and the determined unit latency.

The electronic device of one or more embodiments may simply build and/or train a model by simplifying a detailed model using the latency model and/or the repetition number model corresponding to the function together, in contrast to a typical electronic device that uses only a wall clock time model for determining a wall clock time of an application.

The latency model and the repetition number model corresponding to the function may be modeled and/or trained based on features (e.g., the type or the element affecting the latency) of the function. The latency model and/or repetition number model may include a mathematical model modeled based on a mathematical expression but are not limited thereto, and may include at least one of a machine learning model, a simulator, a neural network, and/or a reinforcement learning model. The mathematical model may be built and/or trained based on the asymptotic notation (e.g., the Big-O notation) indicating time complexity for at least a part of the wall clock model corresponding to the application, the latency model corresponding to the function, or the repetition number model corresponding to the function.

The electronic device, for the calls of the function in a plurality of applications, may determine the latency (or the cumulative latency) of the function call context using the same latency model and/or the same repetition number model. For example, the electronic device may obtain a job description of other applications that are different from the application. The electronic device may determine the latency of the function context called by the other applications using the latency model corresponding to the function in the application based on the application and the other applications including the same function.

For example, a latency model for determining the latency corresponding to one time execution of a cublasDgemm function may have a function argument (e.g., the size of a matrix) and a processor executing the function as important inputs, and the name of an application (or an ID) and call stack information of the function may be unimportant inputs or may not be needed. The cublasDgemm function may use a latency model in common for calls of the cublasDgemm function of a plurality of applications. The latency model commonly used for the calls of the function in the plurality of applications may share a parameter (e.g., a coefficient of the mathematical model) of a model as the same value.

To determine the wall clock time and/or the latency, the wall clock time model outputting a wall clock time of an application, the latency model outputting the latency (or the unit latency) of a function, and the repetition number model outputting the number of repetitions of a function are mainly described herein, but examples are not limited thereto. The electronic device may use a model for determining other elements affecting the wall clock time of the application and/or the latency of the function call context. For example, the electronic device may use a communication amount model that determines the amount of communication to determine the latency of a function call context corresponding to a call of a communication function. In another example, the electronic device may use an operation amount model that determines the amount of operations and/or a core resource utilization model that determines the core resource utilization, for determining the latency of a function call context corresponding to a call of an operation function. An example of a model used to determine the latency of the communication function and the operation function is described in more detail below in an example of a latency model for each type of function.

Candidate models for elements affecting the determination of a wall clock time and/or the latency may be in a plurality, and among the candidate models trained based on a loss function, a candidate model having the maximum accuracy may be selected as a model corresponding to the element. When the accuracy of the plurality of candidate models has a difference less than or equal to a threshold and when an input different from a training input is input (e.g., extrapolated), a candidate model that outputs a value in the threshold range without divergence may be selected as a model. For example, a candidate model based on a mathematical expression with the fixed slope such as a linear expression, a mathematical expression (e.g., a sigmoid) having a lower bound and an upper bound, and/or a mathematical expression (e.g., a logarithm) in which the absolute value of the slope of an output converges to “0” as the value of an input increases may be highly likely to be selected as a model, rather than a model based on a mathematical expression (e.g., a higher degree polynomial and exponent) in which the value of an output diverges as the value of an input increases and/or decreases.

A plurality of elements affecting the determination of a wall clock time and/or the latency may be dependent on each other. For example, a value of a first element may be used to determine a second element. An output of a first model for determining the first element may be used as an input of a second model for determining the second element. For reference, it may be advantageous for the dependence between the elements to form a directed acyclic graph. That is, it may be advantageous not to define an element and/or a model for determining the element so that the cyclic dependency is formed. The electronic device may independently train the first model and the second model to train the first model and the second model for determining the first element and second element dependent on each other. For example, the electronic device may independently train a third model using a training set and/or a loss function that is distinct from a training set and/or a loss function used in the first model and/or the second model. In another example, the electronic device may train a third model using a training set and/or a loss function for the third model when obtaining the third model by coupling (e.g., applying the first model to an input of the second model) the first model to the second model.

The execution time of calls (e.g., a first call and a second call) of a plurality of functions in an application may overlap with each other. The electronic device may define the first function call context corresponding to the first call and the second function call context corresponding to the second call as one third call context and may determine the maximum latency among latencies of the first function call context and the second function call context in the third call context as the latency of the third call context. As a result, the overlapping execution time between the first call context and the second call context may be processed.

An element having a nearly fixed value (e.g., a value in the threshold range) for the function call context may be modeled as a constant. For example, according to a change of the function call context, when an element affecting a wall clock time and/or the latency has a value in the threshold range, the electronic device may model the element as a constant.

When a partial wall clock time estimated according to at least a part of partial models (e.g., a latency model corresponding to a function and a repetition number model corresponding to a function) in the wall clock model is less than or equal to a threshold (or when the proportion of an application in the wall clock time is less than or equal to a threshold rate), the corresponding partial model may be modeled as a constant (or a constant multiple of the wall clock time).

The type of a function may include a communication function and/or an operation function. Hereinafter, examples of a latency model of the communication function and of an operation function are described.

The electronic device may model the latency model corresponding to the communication function for determining the latency of the communication function.

Table 2 below shows examples of arguments of the communication function.

TABLE 2

| Functions | Arguments | Description of Arguments |
|---|---|---|
| MPI_Send | buf | Initial address of send buffer (choice). |
| | count | Number of elements send |
| | | (nonnegative integer). |
| | datatype | Datatype of each send buffer |
| | | element (handle). |
| | dest | Rank of destination (integer). |
| | tag | Message tag (integer). |
| | comm | Communicator (handle). |
| MPI_Recv | count | Maximum number of elements |
| | | to receive (integer). |
| | datatype | Datatype of each receive |
| | | buffer entry (handle). |
| | source | Rank of source (integer). |
| | tag | Message tag (integer). |
| | comm | Communicator (handle). |

First, when the communication speed varies depending on a hardware path used for communication, it may be advantageous to define a latency model differently for each path. As shown in Table 2, in message passing interface peer-to-peer (MPI P2P) communication, the MPI rank of a counterpart may appear in the dest argument in the case of the MPI_Send function and may appear in the source argument in the case of the MPI_Recv function. Additionally, the hardware path used for communication may be known by querying the mapping between the MPI rank and the actual hardware. For reference, when the rank is defined differently depending on the MPI communicator in the comm argument, the mapping must be inquired after first converting the MPI communicator to the rank in the MPI_COMM_WORLD, which is a basic MPI communicator. For example, in the case of 6 MPI Processes, each rank may be defined as 0, 1, 2, 3, 4, and 5 under the basic communicator, which is the MPI_COMM_WORLD. A rank referred to without specific mention may be referred to as such a rank. However, the rank described in the argument of the MPI communication function may refer to the rank under a communicator, which is a comm, which is another argument.

The amount of communication in the MPI P2P communication may be determined based on a function (or an ID of the function) and an argument of the function. In the case of the P2P communication function, such as the MPI_Send function and/or the MPI_Recv function, the amount of communication may be determined based on the count argument indicating the data count and the datatype argument indicating the type of data among the arguments of the function. The size of data may be determined according to the value of the datatype argument, for example, a case in which the datatype argument is the MPI_INT may have a 4-byte size and a case in which the datatype argument is the MPI_DOUBLE may have an 8-byte size. The amount of communication may be determined based on the multiplication of the determined data size and the value of the count argument. As a result, a latency model for predicting the latency (e.g., a communication time) for the MPI P2P communication may be most simply modeled in the form of Equation 2 below, for example.

$$Y = a * X + b \qquad Equation 2$$

Here, an input variable X denotes the amount of communication and an output variable Y denotes a communication time. For reference, a coefficient a to be trained denotes a reciprocal of the speed of a communication path and b denotes the minimum latency of the communication path.

However, the modeling of the amount of communication is not limited to the description above. The amount of communication may generally be modeled separately for each call context. An input of a model for the amount of communication may include a parameter of an application, for example, in the case of a molecular dynamics (MD) application, the amount of communication of the MPI_Send function may be modeled as shown in Equation 3 below, for example.

$$Y = a * {( \frac{A}{N} )}^{\frac{2}{3}} + b * {( \frac{A}{N} )}^{\frac{1}{3}} + c \qquad Equation 3$$

Here, an input variable A denotes an atom count, an input variable N denotes an MPI process count, and an output variable Y denotes the amount of communication.

In this way, a model for determining elements such as the amount of communication and/or the amount of operations may have many cases including a parameter (e.g., the atom count A of Equation 3) of an application indicating the size of the entire problem as an input variable and a process count (e.g., the MPI process count N of Equation 3).

In the MPI collective communication, a transmission and reception target may be all MPI processes in the MPI communicator, including itself. All MPI collective functions may specify the MPI communicator through the comm argument. Depending on a collective communication function (or an ID of a function), a detailed transmission/reception method may vary. For example, in the MPI_Scatter function and the MPI_Bcast function, data may be transmitted from a rank (e.g., a root rank) specified as a root to other ranks (e.g., a one-to-many method). In contrast, in the MPI_Gather function and the MPI_Reduce function, data may be transmitted from all ranks to the root rank (e.g., a many-to-one method). In the MPI_Allgather function, when all ranks act as if all ranks played the role of root in the MPI_Gather function once, data may be transmitted from all ranks to all ranks (e.g., a many-to-many method). In the MPI_Allreduce function, data may be transmitted from all ranks to all ranks similar to performing the MPI_Bcast function after the MPI_Reduce function is performed.

A detailed method of the MPI collective communication may vary depending on an algorithm implementing communication. For example, when the rank in the communicator is 0, 1, 2, 3, 4, 5, . . . and the root rank is 0, the MPI_Bcast function may be implemented with several algorithms. For example, data may be transmitted from rank 0 to each rank of 1, 2, 3, 4, 5, . . . . In another example, data may be transmitted from rank 0 to rank 1, from rank 1 to rank 2, and from rank 2 to rank 3, that is, transmitted in a sequential method. In another example, data may be transmitted from one rank to a plurality of other ranks and from each rank that receives data to a plurality of other ranks, that is, transmitted in a tree method.

In addition, when a certain rank has to perform both a role of receiving data and a role of transmitting data, data may be divided into a block unit and transmitted in the pipeline form for simultaneously performing the data reception and transmission. For example, after a certain rank completes the reception of a first block, the certain rank may transmit the first block to other ranks while receiving a second block. Based on this communication algorithm and/or the communication speed of the communication path, a model for determining the communication time of the communication function may be built. For example, among the collective communication algorithms, a double binary tree may be modeled as shown in Equation 4 below, for example.

$$Y = β n + 2 α log p + \sqrt{8 αβ n log p} \qquad Equation 4$$

Here, Y denotes a communication time, n denotes a data size, and p denotes an MPI process count.

The electronic device may model a latency model corresponding to an operation function for determining the latency of the operation function.

A roofline model may be used to define an execution time (e.g., the latency) for one time of a function call context corresponding to the operation function. The operation function may be performed by executing instructions and the type of operations performed by the instructions may include an operation of a core and data movement between a memory and the core. The number of operations and/or the amount of data movement may vary depending on a function, and the arithmetic intensity may refer to the value obtained by dividing the number of operations by the amount of data movement. The arithmetic intensity may have a unit of Floating-Point Operations/Byte. When the performance of a function includes constantly repeating data movement and operation, among the operation speed (e.g., the operation speed having a unit of Floating-Point Operations/Second) achievable by the function and the data movement speed (e.g., the data movement speed having a unit of Bytes/Second), the slower speed may determine the operation speed. When the value obtained by multiplying the data movement speed by the arithmetic intensity has the same unit as the unit of the operation speed, the data movement speed and the operation speed may be compared with each other. The actual operation speed (e.g., the operation speed having a unit of Floating-Point Operations/Second) of the operation function may be determined with the slower speed between the data movement speed and the operation speed. Thus, the roofline model may include an analysis method that finds the slower speed among two speeds of the operation function.

When the amount of operations and/or the operation speed varies depending on the type of data, a roofline model may be independently built for each operation type. For example, the roofline model may be separately applied to the floating-point operation types with different sizes, such as FP32, FP16, etc., in addition to a 64-bit floating point operation type (e.g., FP64). When an FP64 operator uses more transistors than an FP32 operator, the operation speed of the FP64 may be lower than that of the FP32. Additionally, the roofline model may be separately applied to the integer operation type, the tensor operation type, and other operation types.

When data moves from a main memory to the core, the data may undergo several stages of cache. For example, when the cache is in stage 2, for the core to read the data in the main memory, the data may have to move from the main memory to L2 cache, from the L2 cache to L1 cache, and from the L1 cache to the core. When the cache is a small memory that stores data close to the core, there may have a difference in the amount of data (unit: Byte) that moves for each movement stage and the maximum data movement speed supported by hardware. In general, the farther the cache and/or memory is from the core, the more data movement may be processed and the lower the maximum movement speed (e.g., the movement speed supported by hardware). When the roofline model is applied to here, the lowest speed may be selected among the total four speeds of the core operation speed, the core-L1 cache data movement speed, the L1 cache-L2 cache data movement speed, and the L2 cache-main memory data movement speed. As in the case of no cache, each of the remaining three speeds may have to be multiplied by the arithmetic intensity to become the same unit as the operation speed of the core and the individual arithmetic intensity multiplied by each of the three speeds may be defined respectively. When the amount of data movement for each movement stage is different, the denominator of a mathematical expression for calculating the arithmetic intensity may be different. However, numerators of the arithmetic intensities for the three speeds may be determined based on the amount of operations and may be the same.

A method of determining the minimum speed of the roofline model may be applied to determine the execution time of a function. Among the operation time and the data movement time, the longer one, that is, the maximum time, may be considered as the execution time of the function. The operation time may be calculated by dividing the amount of operations by the operation speed. The data movement time may be calculated by dividing the data movement amount by the data movement speed. When the speed and time are inversely proportional to each other, the determination of the minimum speed in the roofline model may be changed to the determination of the maximum time. When there are several operation types, the time may be calculated for each operation type and summed up. When the data transmission is divided into several stages due to cache, the maximum time among times may be determined as the execution time of a function like the minimum speed among speeds is determined in the roofline model.

However, the method described above may have a limitation in that the method makes an ideal assumption that a program achieves the maximum operation speed or the maximum data movement speed. In most cases, a program may operate at a speed lower than the ideal speed since the program does not use a core resource to the maximum and there may be a high possibility that the function execution time determined according to the method described above is less than the actual time. Accordingly, a more realistic function execution time may be obtained by correcting the ideal function execution time based on the core resource utilization.

The core resource utilization may be defined in various ways according to a processor structure. In the case of a CPU, the instruction level parallelism (ILP) inherent in a function, that is, the instruction count that is simultaneously executable in the maximum may determine the actual achievable operation speed. When the minimum ILP that may busily use a core operator at the most is defined as the ILPM, the core resource utilization for operation type T may be determined as min (1, ILP/ILPM). However, the core resource utilization is not limited to the mathematical expression described above and the core resource utilization may be modeled based on other non-decreasing mathematical expressions for the ILP.

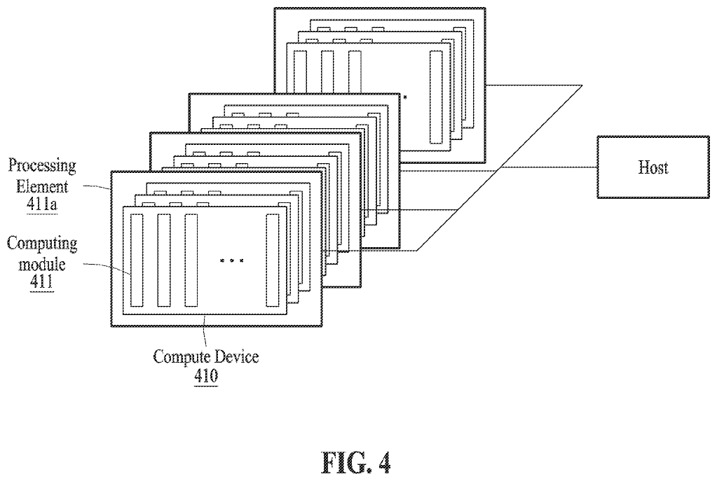

FIG. 4 illustrates an example of an OpenCL platform model.

Accelerators of GPUs or neural processing units (NPUs) specialized for a parallel operation, rather than CPUs, may include several layers, as shown in FIG. 4. The layers may have a homogeneous structure or a heterogeneous structure. One of the methods of using an accelerator in an HPC application may include allocating one compute device 410 to one MPI process, and in this case, one compute device 410 may be used to execute an operation function of the MPI process. That is, a plurality of computing modules (e.g., a computing module 411) in one compute device 410 and a plurality of processing elements (PEs) (e.g., a PE 411a) may simultaneously perform an operation of one function. However, when the parallelism inherent in the function is lacking, both CUs 411 and PEs 411a may not be filled. An example of the parallelism inherent in the function is described in more detail below with reference to FIG. 5. FIG. 5 illustrates an example of parallelism inherent in a function.

FIG. 5 illustrates that the parallelism inherent in an OpenCL function is represented as an NDRange, the NDRange is divided into a unit of a work-group, and the work-group is divided into a unit of a work-item. In a single-instruction-multiple-data (SIMD) processor or a single-instruction-multiple-threads (SIMT) processor, a program counter (PC) may be shared by the PEs in the computing module in a bunch of a predetermined size and executed together, and the bunch may be referred to as a sub-group in the OpenCL terminology, as a warp in the NVIDIA GPU terminology, and a wavefront in the AMD GPU terminology.

Here, like the CPU, the execution time of a function may be corrected through the core resource utilization. The utilization of an accelerator may be defined as a work-item count per sub-group and a sub-group count per computing module. When the work-item count per sub-group is less than the size of the warp or the wavefront, an idle PE may occur and the operation speed may decrease. The sub-group count per computing module may indicate the possibility of using technology (e.g., a warp scheduling of the NVIDIA GPU) that hides the cache miss processing time by executing other waiting sub-groups when a cache miss occurs in one sub-group, and the less the sub-group count per computing module, the more difficult it is to hide the cache miss processing time, so the operation speed may decrease.

Based on a function including types of operations, the electronic device may determine the latency of a function call context using a coefficient of variation (CV) of a ratio of the operation execution time for each operation type for the operation execution time of the operations. When the different operation types are operated simultaneously in a core, including various operation types may be advantageous to decrease the execution time of the function (e.g., the latency of the function call context), rather than having a function configured with a single operation type. The electronic device may correct the latency of the function call context by determining the latency of the function call context using the value obtained by dividing the standard deviation of the execution time for each operation type by an average, that is, the CV. For example, since the increase of the CV means that the operation execution time of the operations is biased on a certain operation type, the function execution time may be estimated longer. For example, the latency of the function call context corresponding to the operation function may be modeled as shown in Equations 5 to 14 below, for example.

$${S}_{i}^{c} = \frac{{O}_{i}}{{OPS}_{i}} \qquad Equation 5$$

Here, Sᵢ^{c} denotes the execution time in a core of an operation type i, Oᵢ denotes the number of operations of the operation type i, and OPSᵢ denotes the number of operations per second of the operation type i.

$${S}^{j} = \frac{{B}^{j}}{{BPS}^{j}} \qquad Equation 6$$

Here, S^{j} denotes the execution time in a memory layer j, B^{j} denotes the amount of data transmission (unit: Byte) in the memory layer j, and BPS^{j} denotes the amount of data transmission per second (unit: Byte/s) in the memory layer j.

$${F}_{i} = \frac{{S}_{i}^{c}}{{\sum }_{k} {S}_{k}^{c}} \qquad Equation 7$$

Here, Fᵢ denotes a proportion of Sᵢ^{c}.

$${F}^{CV} = \frac{std ( \{ {F}_{i} \} )}{mean ( \{ {F}_{i} \} )} \qquad Equation 8$$

Here, F^{CV} denotes a CV of Fᵢ, std({Fᵢ}) denotes the standard deviation of Fᵢ, and mean ({Fᵢ}) denotes an average of Fᵢ.

$${S}_{i}^{j} = \{ \begin{matrix}{S}_{i}^{c} & for j = c \\ {S}^{j} \cdot {F}_{i} & for j ∈ \{ 1 , 2 , m \}\end{matrix} \qquad Equation 9$$

Here, Sᵢ^{j} denotes the core of the operation type i or the execution time in the memory layer j.

$${S}_{i} = {max}_{j} {S}_{i}^{j} \qquad Equation 10$$

Here, Sᵢ denotes the execution time of the operation type i.

$${S}^{*} = {\sum }_{i} {S}_{i} \qquad Equation 11$$

Here, S* denotes an ideal kernel function execution time.

$${E}_{0} = \frac{{a}_{0}}{WPS} + \frac{{a}_{1}}{SPC} + \frac{{a}_{2}}{WPS \cdot SPC} + {a}_{3} \qquad Equation 12$$

Here, E₀ denotes a first kernel function execution time correction value, WPS denotes a work-items per sub-group, SPC denotes a sub-group per computing module, and a₀, a₁, a₂, and a₃ denote trained (or to be trained) coefficients.

$${E}_{1} = {a}_{4} \cdot {F}^{CV} + {a}_{5} \qquad Equation 13$$

Here, E₁ denotes a second kernel function execution time correction value, and a₄ and a₅ denote trained (or to be trained) coefficients.

$$S = {E}_{0} \cdot {E}_{1} \cdot {S}^{*} + {a}_{6} \qquad Equation 14$$

S denotes a corrected kernel function execution time and a₆ denotes a trained (or to be trained) coefficient.

However, the present disclosure is not limited to using a CV based on the operation execution time for each operation type to quantify the degree of bias of the operation type, and other elements that may quantify the degree of bias of the operation type may also be used to determine the latency of the function call context.

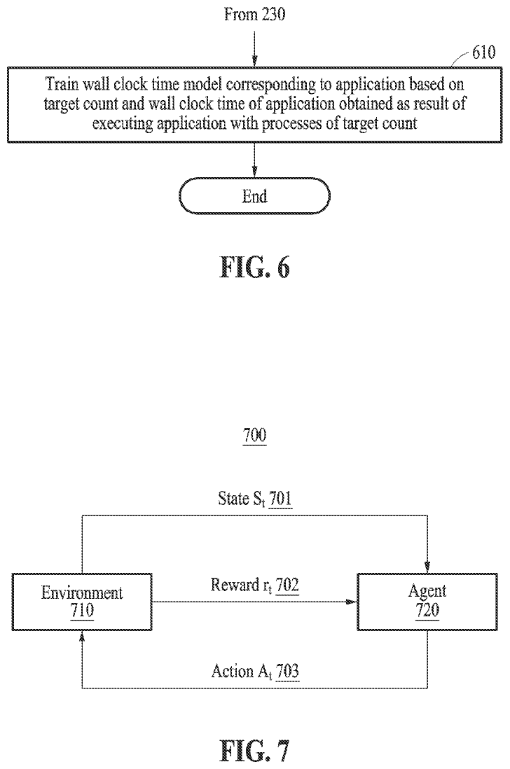

FIG. 6 illustrates an example of training a wall clock time model of an electronic device.

An electronic device (e.g., the electronic device 100 of FIG. 1) may train a wall clock time model corresponding to an application and/or a latency model corresponding to a function using a result of executing the application with processes of a target count.

In operation 610, the electronic device may train the wall clock time model corresponding to the application based on the target count and a wall clock time of the application obtained as a result of executing the application with the processes of the target count.

For example, the electronic device may obtain an input of the wall clock time model (e.g., a target count, an application, a parameter of the application, etc.) based on a job description on the application. The electronic device may output a temporary wall clock time by applying the wall clock time model to the input. The electronic device may obtain a ground truth wall clock time as a result of executing the application with the processes of the target count. The electronic device may calculate a loss value by applying a loss function to the temporary wall clock time and the ground truth wall clock time. The electronic device may update a parameter (e.g., a coefficient) of the wall clock time model so that the loss value converges. The loss function may include a function based on at least one of a least square method (LSM), ridge regression, and LASSO regression.

The electronic device may collect training data (e.g., an input of a corresponding model and a ground truth output of the corresponding model) for a model (e.g., a latency model corresponding to a function, a communication amount model, and an operation amount model) to determine an element affecting the wall clock time in addition to the wall clock time model and train the model based on the collected training date.

The electronic device may determine whether the wall clock time of the application based on the job description is determined, based on obtaining the job description on the application. For example, the electronic device may determine the wall clock time of the application when the wall clock time model corresponding to the application (or the job description on the application) is stored in the database. When the wall clock time model corresponding to the application (or the job description on the application) is not stored in the database, the electronic device may execute the application with the processes of a basic count and build and/or train the wall clock time model based on a result of executing the application.

The electronic device may use the same model for a plurality of applications. For example, the electronic device, for calls of functions in the plurality of applications, may determine the latency (or the cumulative latency) of a function call context using the same latency model and/or the same repetition number model. When a model is commonly used for the plurality of applications, the electronic device may use a trained model according to a result of executing a first application to execute a second application.

For example, based on other applications including the function in the application, the electronic device may train the latency model corresponding to the function using the target count and the latency of the function call context obtained as a result of executing the call of the function in the application with the processes of the target count.

The electronic device may use the common latency model between applications without using an unnecessarily overlapping latency model by using and/or training the latency model corresponding to the function for the plurality of applications when the plurality of applications includes the same function and by building the latency model for each application when there is no change or little change in the latency of the function call context according to the application and/or the parameter of the application.

FIG. 7 illustrates an example of a reinforcement learning model for determining threshold parallelization efficiency.

Referring to FIG. 7, a reinforcement learning model 700 is a reinforcement learning model to determine threshold parallelization efficiency and may include an environment 710 corresponding to a virtual space where a job scheduling is simulated and an agent 720 corresponding to an electronic device. The agent 720 may obtain an action Aₜ 703 based on a state Sₜ 701 obtained from the environment 710, cause a conversion of the state 701 by the action 703, and obtain a reward rₜ 702 according to the conversion of the state 701. The reward 702 may be used for learning of the agent 720.

The agent 720 may determine the state 701 based on information collected from the environment 710. The state 701 may include information on a job description on an application collected from the environment 710 and a result of executing the application. For example, the state 701 may include at least one of pieces of information on a job description on a recently executed application, a process count in which the application is executed, a wall clock time of the application, or the value(s) of a parameter having the wall clock time of the application and a correlation greater than or equal to a threshold. When the state 701 includes the value(s) of a plurality of parameters, the state 701 may be normalized for each parameter.

The reward 702 of the reinforcement learning model 700 is information used for learning of the agent 720 and may be obtained in response to a next state converted by the action 703 from a current state. The conversion into the next state may occur by the action 703 determined by the agent 720 in the current state.

The reward 702 may be determined based on the utilization. The utilization may be calculated by dividing a weighted core time summation by the product of a server core count and server uptime. Here, for simplification of the matter, it may be assumed that one MPI process uses one core and the core may be mapped into one (e.g., a node, 1 CPU core, 1 CPU chip, and 1 GPU chip) of physically various units). The weighted core time summation may be determined by multiplying the time the core executes an application by the parallelization efficiency of the application. The server uptime may represent the execution time of a server. For example, when a server including 30 cores operates for 100 seconds, a first application may be executed for 50 seconds with 12 processes with a parallelization efficiency of 0.8 and a second application may be executed for 80 seconds with 18 processes with a parallelization efficiency of 0.6. In this case, the utilization may be calculated as 0.448 obtained by dividing a weighted core time summation (e.g., 50×12×0.8+80×18×0.6) by the product (e.g., 30×100) of a server core count and the server uptime. The utilization may be calculated as 1 when all cores are executing the application non-stop with 1, the maximum value of parallelization efficiency, and may be calculated as 0 when all cores are not executing the application, and as a result, the utilization may have a value greater than or equal to “0” and less than or equal to “1”. In addition, the utilization may be penalized when the parallelization efficiency is low even when the core executes the application.

When the utilization of a selected action is the maximum value among utilizations at the next time according to actions, the reward rt 702 may be determined as a first value (e.g., 1) and may be determined as a second value (e.g., −1) when the utilization of the selected action is not the maximum value.

As described above, the action 703 is an action of the agent 720 and may include an action indicating the threshold parallelization efficiency. For example, the action of the agent 720 may indicate one of predetermined threshold parallelization efficiencies (e.g., 0.4, 0.6, and 0.8). The agent 720 may learn to determine an optimal action to maximize a long-term reward for future states after the current state. More specifically, the agent 720 may learn to output a selection of the threshold parallelization efficiency expected to provide the highest value as the action 703, from the state 701 corresponding to information on a recently executed application collected from the environment 710.

The agent 720 may determine an action using a value that is an expectation for a summation of rewards corresponding to a future state to which a depreciation rate is applied. For example, a value (e.g., a value when a certain action is taken in the current state) corresponding to the current state and the certain action may be estimated based on the Bellman Equation. The Bellman Equation for estimating a value Q_{π}(s, a) corresponding to a current state s and a certain action a may be expressed as Equation 15 below, for example.

$$\begin{matrix}{Q}_{π} ( s , a ) = {E}_{π} [ {G}_{t} \vert {S}_{t} = s , {A}_{t} = a ] \\ = {E}_{π} [ {R}_{t + 1} + γ {R}_{t + 2} + {γ}^{2} {R}_{t + 3} + … \vert {S}_{t} = s , {A}_{t} = a ] \\ = {E}_{π} [ {R}_{t + 1} + γ ( {R}_{t + 2} + γ {R}_{t + 3} + … ) \vert {S}_{t} = s , {A}_{t} = a ] \\ = {E}_{π} [ {R}_{t + 1} + γ ( {G}_{t + 1} ) \vert {S}_{t} = s , {A}_{t} = a ] \\ = {E}_{π} [ {R}_{t + 1} + γ Q ( {S}_{t} , {A}_{t} ) \vert {S}_{t} = s , {A}_{t} = a ]\end{matrix} \qquad Equation 15$$

In Equation 15, Gₜ denotes a return value at a time t, Rₜ denotes a reward at the time t, γ denotes a depreciation rate for a reward of a future time, and π denotes a probability distribution (e.g., a policy) determining actions in a certain state.

For each of a plurality of actions, the agent 720 may determine at least one of the actions as a target action based on a value when the corresponding action is taken in the current state. According to Equation 16 below, for example, the value Q(s, a) when the certain action a is taken in the current state s may be estimated based on an expectation for a reward Rₜ₊₁ obtained corresponding to the next state converted by the certain action a and a summation Gₜ₊₁ of a reward corresponding to the future state to which the depreciation rate is applied.

The agent 720 may calculate a value corresponding to each state and each action by learning and may determine the action 703 to be taken among actions in the current state obtained based on the calculated value. When the action 703 is determined, the value corresponding to the current state and the determined action may be updated based on a reward obtained by converting into the next state by the action 703 and the value of the next state. The value of the next state may be determined based on values corresponding to the next state and actions available in the next state.

For example, as shown in Equation 16 below, the value Q(s, a) corresponding to the current state s and the determined action a may be updated based on the next state and the highest value (e.g., the maximum value) among values corresponding to actions that may be taken in the next state.

$$Q ( s , a ) = {R}_{a}^{s} + γ {max}_{{a}^{′}} ( {s}^{′} , {a}^{′} ) \qquad Equation 16$$

In Equation 16, s′ denotes a next state, a′ denotes an action in the next state, γ denotes a depreciation rate, and R^{s}ₐ denotes a reward obtained by corresponding to the next state s′ converted by the action a that is determined in the current state s.

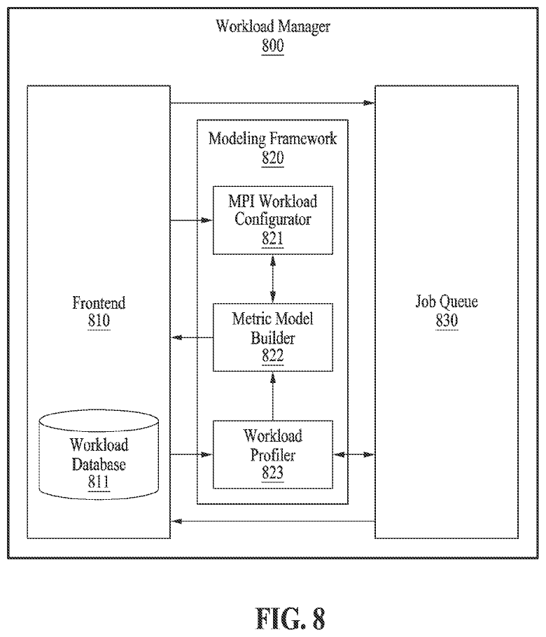

FIG. 8 illustrates an example of an electronic device.

An electronic device (or a workload manager 800) (e.g., the electronic device 100 of FIG. 1) may include a frontend 810, a modeling framework 820, and a job queue 830.

The frontend 810 may obtain a job description on an application (or expressed as a workload). The frontend 810 may check the validity of the obtained job description. The validity may refer to whether the application is executed according to the job description and may include, for example, whether the job description created in a computer programming language is compiled. The frontend 810 may include a workload database 811 and may determine whether the application (or the job description on the application) is stored (or registered) in the workload database 811. The frontend 810 may transmit the application and the job description on the application to the modeling framework 820 when the application (or the job description on the application) is stored (or registered) in the workload database 811. When the application (or the job description on the application) is not stored (or registered) in the workload database 811, the frontend 810 may immediately execute the application by transmitting the application and the job description on the application to the job queue 830 and may collect training data of a model by transmitting the application and the job description on the application to the modeling framework 820.

The modeling framework 820 may include an MPI workload configurator 821, a metric model builder 822, and a workload profiler 823.

When the application (or the job description on the application) is stored (or registered) in the workload database 811, the MPI workload configurator 821 may receive an execution policy (e.g., the execution with a process count having parallelization efficiency less than or equal to threshold parallelization efficiency) from a system manager and may modify the job description on the application to an MPI process count (e.g., a target count) that may most effectively execute the policy.

The workload profiler 823 may receive the application and the job description on the application executable by the frontend 810 and perform profiling from various viewpoints. For example, the workload profiler 823 may collect data on an element affecting a wall clock time of an application including a wall clock time of an application, the latency of a function call context, the amount of communication of a communication function, and/or the amount of operations of an operation function. The data may be collected through a profiler for each viewpoint when an application is executed. In an example as described in detail below, the collected data may be transmitted to the metric model builder 822 and used to build and/or train a metric model.

The metric model builder 822 may receive data collected from the workload profiler 823 and build and/or train a model (e.g., a wall clock time model, a latency model, a communication amount model, and an operation amount model) for each metric (or each element). The model may represent a correlation between a process count and a corresponding metric. Based on the generation of a model for determining an element (e.g., a metric) affecting a wall clock time of an application, the metric model builder 822 may transmit information including the completion of modeling for the element (e.g., the metric) to the frontend 810.

The job queue 830 may execute an application based on a job description received from the modeling framework 820 and return a result of executing the application.

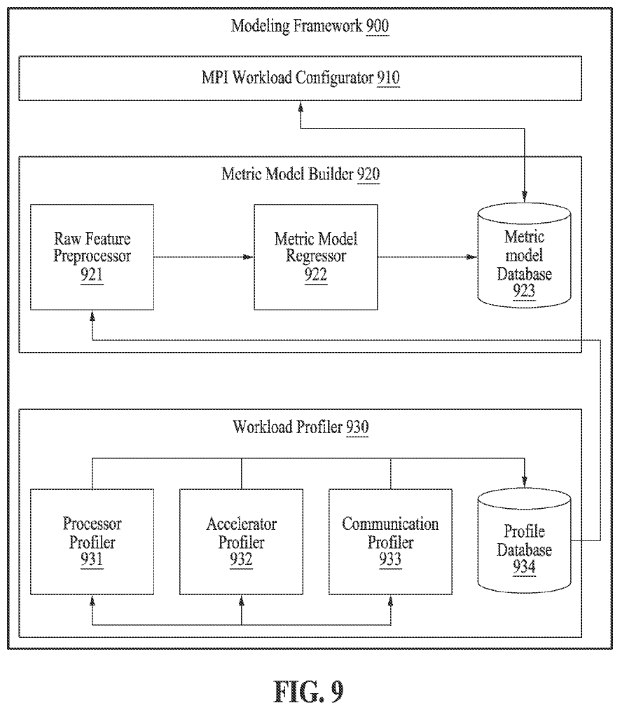

FIG. 9 illustrates an example of a modeling framework.

A modeling framework 900 (e.g., the modeling framework 820 of FIG. 8) may include an MPI workload configurator 910 (e.g., the MPI workload configurator 821 of FIG. 8), a metric model builder 920 (e.g., the metric model builder 822 of FIG. 8), and a workload profiler 930 (e.g., the workload profiler 823 of FIG. 8).

The workload profiler 930 may include a processor profiler 931, an accelerator profiler 932, a communication profiler 933, and a profile database 934.

The processor profiler 931 may receive an application and a job description of the application from the frontend 810. The processor profiler 931 may extract all events that occur in a processor while the application is executing. The events may include the same type of functions, and each function may include a parameter, an argument, and information (e.g., a start timestamp and an end timestamp) on a start time and an end time. The events and functions may be predefined in the profiling technique. The extracted information may be stored in the profile database 934.

The accelerator profiler 932 may receive an application and a job description on the application from the frontend 810. The accelerator profiler 932 may extract performance monitoring units of an accelerator and trace of all kernels with arguments while the application is executing. For reference, the kernel may be processed as the type of a function. The extracted information may be stored in the profile database 934.

The communication profiler 933 may receive an application and a job description on the application from the frontend 810. The communication profiler 933 may extract an MPI call trace with an argument while the application is executing. The extracted information may be stored in the profile database 934.

The profile database 934 may receive and/or store information extracted through at least one of the processor profiler 931, the accelerator profiler 932, and the communication profiler 933. The profile database 934 may provide information requested by the metric model builders 920 and 822.

The metric model builder 920 may receive data collected through profiling, standardize the received data, define a model representing a relationship between a function and an element (e.g., a metric), and train the model through the standardized data (e.g., the training data). The metric model builder 920 may include a raw feature preprocessor 921, a metric model regressor 922, and a metric model database 923.

The raw feature preprocessor 921 may join data generated from a profiler (e.g., the processor profiler 931, the accelerator profiler 932, and the communication profiler 933), and standardize the data as the form of a context. The context may include a relationship table between a function, a parameter (or an argument), and an element (e.g., a metric) according to the type of the function. All generated contexts may be transmitted to the metric model regressor 922.

The metric model regressor 922 may train predefined models (e.g., polynomial-based mathematical expression models) for each context and element (e.g., a metric) and store a model having the maximum prediction performance among the models in the metric model database 923.

The metric model database 923 may store a model generated by the metric model regressor 922. The metric model database 923 may return a model corresponding to the context and element based on receiving a request based on the context and element from the MPI workload configurator 910.

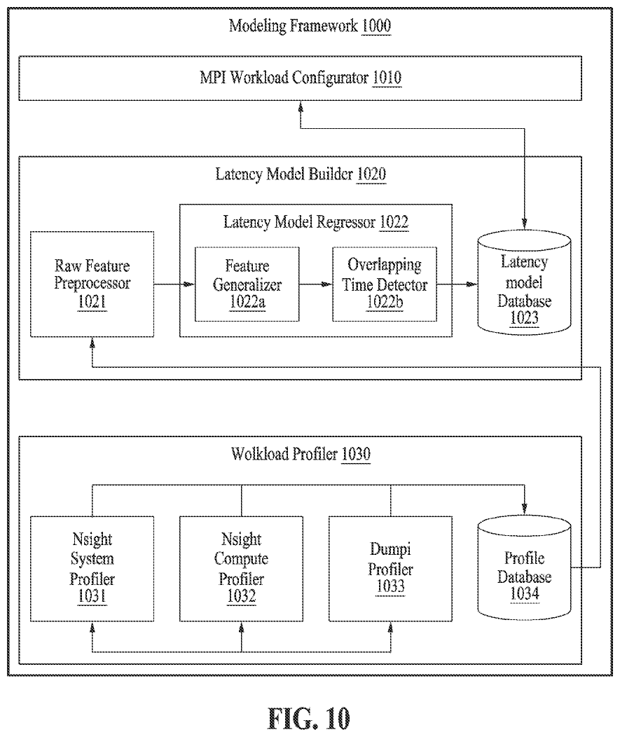

FIG. 10 illustrates an example of a modeling framework.

A modeling framework 1000 (e.g., the modeling framework 820 of FIG. 8 and the modeling framework 900 of FIG. 9) may include an MPI workload configurator 1010 (e.g., the MPI workload configurator 821 of FIG. 8 and the MPI workload configurator 910 of FIG. 9), a latency model builder 1020 (e.g., the metric model builder 822 of FIG. 8 and the metric model builder 920 of FIG. 9), and a workload profiler 1030 (e.g., the workload profiler 823 of FIG. 8 and the workload profiler 930 of FIG. 9).

The modeling framework 1000 may set an MPI process count of Lammps ReaxFF Potential among MPI-based HPC applications.

The workload profiler 1030 may include an Nsight system profiler 1031, an Nsight compute profiler 1032, and a Dumpi profiler 1033, and a profile database 1034.

The Nsight system profiler 1031 may extract execution information on an MPI call and an Nvidia GPU cuda kernel for a processor. The Nsight compute profiler 1032 may extract hardware information on the Nvidia GPU cuda kernel. The Dumpi profiler 1033 (or the Intel Trace Analyzer & Collector) may extract execution information on the MPI call.

The latency model builder 1020 may include a raw feature preprocessor 1021, a latency model regressor 1022, and a metric model database 1023. The latency model regressor 1022 may include a feature generalizer 1022a and an overlapping time detector 1022b.

The raw feature preprocessor 1021 may generate context information, and the generated context information may be used to train a latency model. However, the latency model may have low prediction accuracy for an input that is out of the range of features of training input data used in training. To mitigate this phenomenon, the feature generalizer 1022a may generate a generalized feature and train the latency model using the generalized feature.

In addition, at least a part of time ranges of contexts may overlap. When the overlapping time range interrupts the determination of a wall clock time, an actual wall clock time may be determined through modeling for the overlapping time range. The overlapping time detector 1022b may determine the actual wall clock time of an application by modeling and removing the overlapping time.

The electronic devices, processors, memories, communicators, compute devices, computing modules, PEs, workload managers, frontends, modeling frameworks, job queues, MPI workload configurators, metric model builders, workload profilers, raw feature preprocessors, metric model regressors, metric model databases, processor profilers, accelerator profilers, communication profilers, profile databases, latency model builders, latency model regressors, Nsight system profilers, Nsight compute profilers, Dumpi profilers, electronic device 100, processor 110, memory 120, communicator 130, compute device 410, computing module 411, PE 411a, workload manager 800, frontend 810, modeling framework 820, job queue 830, MPI workload configurator 821, metric model builder 822, workload profiler 823, modeling framework 900, MPI workload configurator 910, a metric model builder 920, workload profiler 930, raw feature preprocessor 921, metric model regressor 922, metric model database 923, processor profiler 931, accelerator profiler 932, communication profiler 933, profile database 934, modeling framework 1000, MPI workload configurator 1010, latency model builder 1020, workload profiler 1030, raw feature preprocessor 1021, latency model regressor 1022, metric model database 1023, Nsight system profiler 1031, Nsight compute profiler 1032, Dumpi profiler 1033, profile database 1034, and other apparatuses, devices, units, modules, and components disclosed and described herein with respect to FIGS. 1-10 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A process-implemented method, the method comprising:
based on obtaining a job description on an application, determining a wall clock time of the application according to processes of a corresponding candidate count for each of a plurality of candidate counts;
determining parallelization efficiency for each of the candidate counts based on the determined wall clock time and a wall clock time of the application according to a single process; and
executing the application with processes of a target count selected based on the determined parallelization efficiency among the plurality of candidate counts.

2. The method of claim 1, wherein
the determining of the wall clock time comprises, for a call of a function in the application, determining latency of a function call context, and
the function call context comprises any one or any combination of any two or more of the application, a parameter of the application, the function, an argument of the function, a call stack of the function, hardware allocated to the function, a mapping relationship between a process and hardware, and a global variable.

3. The method of claim 2, wherein the determining of the latency of the function call context comprises a cumulative latency of the function call context using a unit latency of the function call context and a number of repetitions of the function call context, based on repetition of the function call context.

4. The method of claim 2, wherein the determining of the latency of the function call context comprises determining a number of repetitions of the function call context based on the function call context.

5. The method of claim 2, wherein the determining of the latency of the function call context comprises, in response to a difference between a first function call context and a second function call context being less than or equal to a threshold, determining that one of the first function call context and the second function call context is repeatedly performed.

6. The method of claim 2, wherein the determining of the latency of the function call context comprises, based on the function comprising a plurality of types of operations, determining the latency of the function call context using a coefficient of variation (CV) of a ratio of an operation execution time for each operation type for an operation execution time of the operations.

7. The method of claim 1, further comprising:
obtaining a job description on other applications; and
determining latency of a function context called by the other applications using a latency model corresponding to a function in the application, based on the application and the other applications comprising the same function.

8. The method of claim 1, further comprising training a wall clock time model corresponding to the application based on the target count and a wall clock time of the application obtained as a result of executing the application with processes of the target count.

9. The method of claim 8, wherein the training of the wall clock time model comprises, based on other applications comprising a function in the application, training a latency model corresponding to the function using the target count and latency of a function call context obtained as a result of executing a call of the function in the application with processes of the target count.

10. The method of claim 1, wherein the executing of the application comprises selecting a candidate count having a minimum wall clock time as the target count among candidate counts having parallelization efficiency greater than or equal to threshold parallelization efficiency.

11. An electronic device comprising:
one or more processors configured to:
based on obtaining a job description on an application, determine a wall clock time of the application according to processes of a corresponding candidate count for each of a plurality of candidate counts;
determine parallelization efficiency for each of the candidate counts based on the determined wall clock time and a wall clock time of the application according to a single process; and
execute the application with processes of a target count selected based on the determined parallelization efficiency among the plurality of candidate counts.

12. The electronic device of claim 11, wherein
for the determining of the wall clock time comprises, the one or more processors are configured to, for a call of a function in the application, determine latency of a function call context, and
the function call context comprises any one or any combination of any two or more of the application, a parameter of the application, the function, an argument of the function, a call stack of the function, hardware allocated to the function, a mapping relationship between a process and hardware, and a global variable.

13. The electronic device of claim 12, wherein, for the determining of the latency of the function call context, the one or more processors are configured to determine a cumulative latency of the function call context using a unit latency of the function call context and a number of repetitions of the function call context, based on repetition of the function call context.

14. The electronic device of claim 12, wherein, for the determining of the latency of the function call context, the one or more processors are configured to determine a number of repetitions of the function call context based on the function call context.

15. The electronic device of claim 12, wherein, for the determining of the latency of the function call context, the one or more processors are configured to, in response to a difference between a first function call context and a second function call context being less than or equal to a threshold, process that one of the first function call context and the second function call context is repeatedly performed.

16. The electronic device of claim 12, wherein, for the determining of the latency of the function call context, the one or more processors are configured to, based on the function comprising a plurality of types of operations, determine the latency of the function call context using a coefficient of variation (CV) of a ratio of an operation execution time for each operation type for an operation execution time of the operations.

17. The electronic device of claim 11, wherein the one or more processors are configured to:
obtain a job description on other applications; and
determine latency of a function context called by the other applications using a latency model corresponding to a function in the application, based on that the application and the other applications comprising the same function.

18. The electronic device of claim 11, wherein the one or more processors are configured to train a wall clock time model corresponding to the application based on the target count and a wall clock time of the application obtained as a result of executing the application with processes of the target count.

19. The electronic device of claim 18, wherein, for the training of the wall clock time model, the one or more processors are configured to, based on other applications comprising a function in the application, train a latency model corresponding to the function using the target count and latency of a function call context obtained as a result of executing a call of the function in the application with processes of the target count.

20. The electronic device of claim 11, wherein, for the executing of the application, the one or more processors are configured to select a candidate count having a minimum wall clock time as the target count among candidate counts having parallelization efficiency greater than or equal to threshold parallelization efficiency.
